(19) United States
(12) Patent Application Publication
(10) Pub. No.: US 2024/0014486 A1
(43) Pub. Date: Jan. 11, 2024

(54) METHOD FOR PERMANENTLY SEALING HOLES WITH OVERPRESSURE PROTECTION AND BONDING ELEMENT FOR THE METHOD

(71) Applicant: tesa SE, Norderstedt (DE)

(72) Inventors: Magdalena SOMMER, Norderstedt (DE); Katja MEYER, Norderstedt (DE); Thomas NIEMEYER, Norderstedt (DE); Kenny KLOBEDANZ, Norderstedt (DE); Jennifer KIPKE, Norderstedt (DE)

(73) Assignee: tesa SE, Norderstedt (DE)

(21) Appl. No.: 18/220,087

(22) Filed: Jul. 10, 2023

(30) Foreign Application Priority Data
Jul. 11, 2022 (DE) 102022117176.0

(51) Int. Cl. H01M 50/184; F16J 15/14; H01M 50/342; B32B 27/06; B32B 7/12

(52) U.S. Cl. CPC H01M 50/184; F16J 15/14; H01M 50/3425; B32B 27/06; B32B 7/12; B32B 2581/00

(57) ABSTRACT

Methods may seal or seal a continuous clearance in a substrate and comprise a) producing or providing a bonding element comprising: i) an adhesive layer comprising an adhesive, ii) a carrier layer disposed on the adhesive layer and comprising a first carrier ply, and b) adhering the bonding element by means of the adhesive layer to the substrate, so that the bonding element completely covers the continuous clearance and the continuous clearance is fluid-tightly sealed by the bonding element. The bonding element comprises a pressure opening region which is surrounded at least sectionally by a weakening region formed in the carrier layer, the mean thickness of the carrier layer in the weakening region being lower than the mean thickness of the carrier layer in the pressure opening region.

This application claims foreign priority benefit under 35 U.S.C. § 119 of German Application No. 10 2022 117 176.0 filed Jul. 11, 2022.

The disclosure is directed to a method for sealing a continuous clearance in a substrate, to a corresponding overpressure-protected substrate, to a bonding element for permanently sealing holes with overpressure protection, and to use of corresponding bonding elements for permanently sealing a hole in a substrate and for producing overpressure protection.

In the production of complex products, manufacturing reasons in many cases dictate the need, in the substrates and components processed, to provide holes through which further operations can be carried out in the course of production, these holes, for example, enabling access to an interior in which further constituents are to be disposed. At the end of the production process, however, these holes in many cases are no longer necessary and are even a drawback for numerous end applications, because, for example, they enable the ingress of moisture or contaminants. For this purpose it is known practice in the prior art to provide such continuous clearances in substrates, in the course of manufacture, with permanent sealing, and here in particular the use of bonding elements, examples being so-called diecuts, represents an efficient possibility of permanently sealing holes, as is disclosed for example in EP 3569406 A1, EP 3943283 A1 or EP 3992259 A1.

In many cases, however, continuous clearances in the substrate serve not only for manufacturing purposes. Instead it may be necessary to be able to influence the pressure in the interior of substrates, for example battery casings; for the pressure management necessary for this purpose, suitable pressure regulation devices, in the form of valves, for example, must be provided in the region of the continuous clearances.

Particular importance in the pressure management area in the interior of substrates is possessed by so-called overpressure protections, sometimes also referred to as “bursting systems”. Overpressure protections of this kind, with a usually relatively complex construction, are used, for example, in electronic devices to protect the installed components and they make it possible to achieve pressure equalization with the surrounding environment when a defined internal pressure is reached, allowing the overpressure to be released in a venting procedure.

Corresponding overpressure protections are relevant here in particular not least for battery casings, as are nowadays employed in the electric vehicle area, for example. These battery casings house in their interior the constituents of the electrochemical cells that serve for electrochemical storage and recovery of energy and take the form, for example, of so-called pouch cells. Corresponding electrochemical cells, examples being lithium-ion batteries, represent complex systems which in certain cases are also susceptible to faults, especially since in many cases they comprise combustible substances, especially electrolytes, and since high temperatures may occur in operation.

With batteries, consequently, a possible worst-case scenario is that referred to as thermal runaway. In the event of such thermal runaway, the gases released and/or liquid components evaporated lead in many cases to severe build-up of pressure in the interior of the battery casing, possibly leading to uncontrolled destruction of the battery casing, which may in turn cause damage to surrounding battery casings, and so in the worst case an unwanted chain reaction may result.

For this reason, performance-capable overpressure protections are particularly safety-relevant for battery casings. The increasing relevance of electric vehicles in the area of the vehicle industry and the increasing use of electrochemical energy stores mean, accordingly, that there is nowadays a continual interest in improving overpressure protections which are especially suitable for use with battery casings.

One overpressure protection known from the prior art is disclosed for example in CN 107178638 A. The overpressure safeguards known from the prior art are in many cases technically complex components which in general have to be fitted into the continuous clearances in the substrates, involving much manufacturing cost and effort, and which have a comparatively high inherent weight and a certain inherent volume. Moreover, corresponding prior-art bursting systems must frequently be designed specifically for defined hole geometries and in many cases cannot be adapted flexibly to different dimensions of the holes that are to be sealed.

The primary object of the present disclosure was to eliminate or at least reduce the disadvantages of the prior art.

A particular object of the present disclosure was to specify a method for sealing a continuous clearance in a substrate that enables reliable and fluid-tight sealing of the continuous clearances and yet enables reliable release of pressure by venting in the event of an overpressure.

It was an object of the present disclosure that the method to be specified ought to be able to be carried out using components which require as small a footprint as possible and have a low inherent weight.

It was an object of the present disclosure, moreover, that the sealing of the continuous clearances in the method to be specified should be possible in a particularly simple manner and that desirably an easy capacity for automation should be ensured.

It was a further object of the present disclosure that the method to be specified should be able to be carried out in a particularly time- and cost-efficient manner, in particular with high throughput rates, and also, desirably, that the storage costs associated with storing the components to be used in the method should be as low as possible.

It was a supplementary object of the present disclosure that the method to be specified should be suitable with particular flexibility, as a result of the components to be used, for sealing continuous clearances having different hole geometries and that ideally no specific adaptation of the components used should be necessary for different hole geometries.

It was a further object of the present disclosure that the hole sealing possible with the method to be specified, up to the onset of the overpressure protection, should be particularly reliable and long-lasting. Accordingly, it was a supplementary object of the present disclosure that the overpressure protection produced with the method to be specified should enable a pronounced directional dependency of the overpressure protection, so that an overpressure acting on the seal from the outside should not lead to pressure equalization even with high overpressures.

In the light of the observations above, it was an object of the present disclosure to specify an overpressure-protected substrate produced with the method to be specified.

It was an object of the present disclosure, moreover, to specify a component for permanently sealing holes with overpressure protection that can be used in the method to be specified and, moreover, to specify a use based on this component.

The inventors of the present disclosure have now found that the objects described above may surprisingly be achieved if, instead of complex, constructional bursting systems for sealing continuous clearances in substrates, specific bonding elements are used with which the continuous clearance can be bonded over in fluid-tight manner, but which, as a result of a weakening in the carrier layer, comprise a pressure opening region which breaks open largely irreversibly in the event of a predetermined opening pressure, so that pressure equalization can take place through the resultant through hole in the bonding element, this equalization being as defined in the claims.

Surprisingly, this design of bonding elements and their use in corresponding methods enables not only reliable and fluid-tight sealing of continuous clearances in substrates but also a reliable opening behavior, which is precisely adjustable via the extent of the weakening of the carrier layer, in the event of an overpressure. The inventors here have found that the comparatively simple design of the bonding element and also its simple application result in a particularly advantageous method.

In terms of their application, the corresponding bonding elements not only are particularly easy to automate and inexpensive to manufacture, but also possess a particularly low inherent weight and inherent volume. The corresponding bonding elements and hence the corresponding method advantageously have a high tolerance for deviations in the hole geometry, so enabling broader manufacturing tolerances and allowing the bonding elements employed to be used for sealing continuous clearances having different dimensions.

The objects stated above are therefore achieved by the subject matter of the disclosure as defined in the claims. Preferred embodiments of the disclosure are apparent from the dependent claims and the observations which follow.

Embodiments designated hereinafter as being preferred are combined, in particularly preferred embodiments, with features of other embodiments designated as being preferred. Especially preferred combinations, therefore, are those of two or more of the embodiments designated hereinafter as being particularly preferred. Likewise preferred are embodiments in which a feature of one embodiment, designated to any extent as being preferred, is combined with one or more further features of other embodiments which are designated to any extent as being preferred. Features of preferred bonding elements, overpressure-protected substrates and uses are apparent from the features of preferred methods.

The disclosure relates to a method for sealing a continuous clearance in a substrate, comprising the method steps of:
a) producing or providing a bonding element comprising:
   i) an adhesive layer comprising an adhesive,
   ii) a carrier layer disposed on the adhesive layer and comprising a first carrier ply, and
b) adhering the bonding element by means of the adhesive layer to the substrate, so that the bonding element completely covers the continuous clearance and the continuous clearance is fluid-tightly sealed by the bonding element,
wherein the bonding element comprises a pressure opening region which is surrounded at least sectionally by a weakening region formed in the carrier layer, the mean thickness of the carrier layer in the weakening region being lower than the mean thickness of the carrier layer in the pressure opening region, wherein the bonding element is configured such that the action of a predetermined opening pressure on the pressure opening region at least partly irreversibly destroys the bonding element in the weakening region and forms a through hole in the bonding element, and wherein the bonding element is adhered such that the pressure opening region at least partly covers the continuous clearance in the substrate.

The method of the disclosure serves for the sealing, more particularly the fluid-tight sealing, of continuous clearances in substrates, more particularly of holes, and in practice is particularly relevant to the sealing of those holes through which an interior in the substrate is in fluid communication with the surroundings. Preferred correspondingly is a method of the disclosure wherein the substrate comprises an interior which is fluid-tightly sealed by the adhering of the bonding element to the continuous clearance.

An advantageous feature of the method of the disclosure is the substantial absence of limitation on the nature of the substrate. In the estimation of the inventors, however, the method of the disclosure is particularly suitable for use in the sealing of battery casings, since in many cases these casings, owing to the high number of individual elements, benefit particularly greatly from the low weight and the low manufacturing costs of the solution found in the context of the present disclosure. Preferred accordingly in particular is a method of the disclosure wherein the substrate is a casing, preferably a casing of an electronic device or a battery, particularly preferably of a battery. Preferred additionally or alternatively is also a method of the disclosure wherein the substrate comprises one or more materials selected from the group consisting of metals, composite materials, comprising glass or carbon fibers, for example, and plastics, preferably plastics and metals, particularly preferably metals, more particularly coated metals.

The skilled person understands that a corresponding substrate may also comprise more than one continuous clearance, but that in that case it is preferred if all of the clearances are sealed with the method of the disclosure. Alternatively, however, the continuous clearances present in the substrate could also be sealed in some cases with the method of the disclosure and in some cases in other ways, for example with conventional bonding elements without overpressure protection. Preference is given, accordingly, to a method of the disclosure wherein the substrate comprises two or more continuous clearances, where preferably all of the continuous clearances are sealed with the method.

In agreement with the understanding of the skilled person, the bonding element to be used in the method of the disclosure is a sheetlike bonding element, meaning that it has a significantly greater extent in the two spatial directions of one plane than in the direction orthogonal to the plane. Corresponding bonding elements here may be produced, for example, using methods of the kind highly familiar to the person skilled in the field of the art and which are also employed, for example, in the production of other bonding elements. Typically, corresponding sheetlike bonding elements are singulated by a suitable cutting method from a larger adhesive assembly produced beforehand, and so the bonding elements are available in large quantities. Singulation may take place, for example, by diecutting of the bonding elements, in which cases the element is usually referred to as a diecut. Preferred, therefore, is a method of the disclosure wherein the bonding element is produced by diecutting the bonding element from an adhesive assembly comprising an adhesive ply and a carrier ply disposed on the adhesive ply, with the weakening region being produced preferably prior to the diecutting. Particularly preferred, accordingly, is a method of the disclosure wherein the bonding element is a diecut.

Alternatively to the production of the bonding elements in the method, by cutting, for example, they may also be merely provided in the method of the disclosure, however, by being bought from a supplier, for example.

The bonding elements used comprise an adhesive layer and a carrier layer which are joined to one another, as is known to the person skilled in the art of adhesive technology from numerous adhesive tapes and comparable bonding products. The adhesive layer serves to adhere the bonding element to the substrate and ensures the necessary adhesion of the bonding element on the substrate so as to prevent unwanted, premature detachment in the case of relatively low pressure differences between the two sides of the substrate or in the case of other mechanical loading.

With a view to a method regime of maximum efficiency, making it possible in particular for the bonding elements to be applied particularly easily, but also, where necessary, permitting simple correction of an imperfect application, the inventors propose implementing the adhesive as a pressure-sensitive adhesive. Preferred, correspondingly, is a method of the disclosure wherein the adhesive is a pressure-sensitive adhesive.

A pressure-sensitive adhesive (PSA), in agreement with the understanding of the skilled person, is an adhesive which possesses pressure-sensitive adhesive properties, i.e. has the capacity to enter into a durable bond to a substrate even under relatively weak applied pressure. Corresponding pressure-sensitive adhesive tapes have in general a permanent inherent tack even at room temperature, meaning that they have a certain viscosity and touch-tackiness, so that they wet the surface of a substrate even under low applied pressure. Without wishing to be tied to this theory, it is frequently assumed that a PSA may be considered to be a fluid of extremely high viscosity with an elastic component, accordingly having characteristic viscoelastic properties which lead to the above-described permanent inherent tackiness and pressure-sensitive adhesive capability. It is assumed that with such PSAs, on mechanical deformation, there are viscous flow processes and there is development of elastic forces of resilience. The viscous flow component serves for achieving adhesion, while the elastic forces of resilience component is needed in particular for the achievement of cohesion. The relationships between the rheology and the pressure-sensitive adhesiveness are known in the prior art and described for example in Satas, “Handbook of Pressure Sensitive Adhesive Technology”, third edition, (1999), pages 153 to 203. To characterize the degree of elastic and viscous components, it is usual to employ the storage modulus (G′) and the loss modulus (G″), which may be ascertained by dynamic mechanical analysis (DMA), using a rheometer, for example, as disclosed for example in WO 2015/189323. For the purposes of the present disclosure, an adhesive is understood preferably to have pressure-sensitive adhesiveness and hence to be a PSA when at a temperature of 23° C. in the deformation frequency range from 10⁰ to 10¹ rad/sec, G′ and G″ are each situated at least partly in the range from 10³ to 10⁷ Pa.

As a possible alternative embodiment to the preferred embodiment as a PSA, described above, it is conceivable to implement the adhesive as a reactive adhesive, i.e. as adhesive which cures only as a result of a curing step, with the resultant curing of the adhesive and the effect thereof as a structural adhesive making this embodiment of particular interest for applications where comparatively high predetermined opening pressures are to be set. Preferred for certain applications, therefore, is a method of the disclosure wherein the adhesive is a curable adhesive, preferably a radiation-curing and/or thermally curing adhesive, in which case the method preferably additionally comprises, after method step b), the following method step:

c) at least partly curing the curable adhesive.

In the estimation of the inventors, it may be seen as a major advantage of the method of the disclosure that it is very flexible in terms of the chemical nature of the adhesive used in the bonding element. The fundamental functionality of the method of the disclosure comes about in particular, in the estimation of the inventors, from the interaction of a specifically weakened carrier layer with a generic adhesive, and is thus not limited to chemically specific adhesives. This makes it possible advantageously for suitable adhesives to be selected in light of the other application requirements, especially in terms of the adhesion on the respective substrate and/or the temperature stability for the target application areas. The inventors have therefore, however, succeeded in identifying adhesives with which, in their estimation, particularly performance-capable bonding elements may be obtained. Preferred, indeed, is a method of the disclosure wherein the adhesive comprises one or more polymers selected from the group consisting of polyurethanes, poly(meth)acrylates and synthetic rubbers, preferably poly(meth)acrylates and synthetic rubbers, particularly preferably poly(meth)acrylates.

In the context of the present disclosure, the expression “poly(meth)acrylates”, in agreement with the understanding of the skilled person, embraces polyacrylates and polymethacrylates and also copolymers of these polymers. Poly(meth)acrylates may contain relatively small amounts of monomer units which do not derive from (meth)acrylates. A “poly(meth)acrylate” is understood in the context of the present disclosure, accordingly, to be a (co)polymer whose monomer basis consists to a mass fraction of 70% or more, preferably 90% or more, particularly preferably 98% or more, of monomers selected from the group consisting of acrylic acid, methacrylic acid, acrylic esters and methacrylic esters, based on the mass of the monomer basis. The mass fraction of acrylic ester and/or methacrylic ester is preferably 50% or more, particularly preferably 70% or more. Poly(meth)acrylates are obtainable generally through radical polymerization of acrylic- and/or methacrylic-based monomers and also, optionally, further, copolymerizable monomers.

In the estimation of the inventors, it is advantageous for certain end applications to implement the adhesive as a foamed adhesive, for example as a syntactically foamed adhesive which employs expanded microballoons, as are known fundamentally from the prior art, or as a physically foamed adhesive, which may be generated using a blowing gas, for example. Such foamed adhesives frequently have advantages in particular in relation to shock resistance. Accordingly, it may be seen as an advantage of the method of the disclosure that the foaming of the adhesive, in the estimation of the inventors, does not stand in the way of the fundamental functionality of the bonding elements of the disclosure. Preferred for certain applications, accordingly, is a method of the disclosure wherein the adhesive is a foamed adhesive, the adhesive preferably being a physically foamed adhesive and/or comprising one or more components selected from the group consisting of hollow spheres and at least partly expanded microballoons.

With a view to extremely material-sparing production and good handling properties, the inventors propose that the dimensions of the adhesive layer and of the carrier layer should be extremely similar. Although for some applications it may be preferable to allow the carrier layer to protrude over the adhesive layer, it is preferable, especially with a view to manufacturing efficiency, for this layer to be completely covered by the adhesive layer. Preferred accordingly is a method of the disclosure wherein the carrier layer on one side is covered by the adhesive layer to an extent of 50% or more, preferably 70% or more, particularly preferably 90% or more, especially preferably 95% or more, more particularly preferably substantially completely.

In accordance with the disclosure, the carrier layer comprises a first carrier ply, and in practice in many cases the carrier layer will consist substantially of this carrier ply. Relevant for the majority of embodiments, moreover, is a method of the disclosure wherein the adhesive layer is disposed on the first carrier ply.

In this context, it may be seen as an advantage that the method of the disclosure is fundamentally very flexible in terms of the selection of materials for the first carrier ply and that the skilled person is able to have recourse to typical materials which are already known as carrier materials in the area of adhesive technology. Accordingly, however, the inventors have succeeded in identifying suitable materials with which very reliable and powerful bonding elements for use in the method of the disclosure may be obtained in every case. Preference is given, indeed, to a method of the disclosure wherein the first carrier ply comprises a foil selected from the group consisting of polymeric foils, examples being polyester foils, PEEK foils, PAEK foils, polyimide foils or polyamide foil, more particularly polyester foils, and metal foils, preferably metal foils. Preferred additionally or alternatively is a method of the disclosure.

Especially for relatively demanding applications, as for example when the adhesive seal is subject in use to heavy expected thermal and/or chemical and/or mechanical loading, it is possible for the carrier layer to comprise not only the first carrier ply but also further carrier plies, which serve, for example, for optimizing the physicochemical properties, especially the surface properties. Preference is given to a method of the disclosure wherein the carrier layer comprises one or more, preferably two or more, particularly preferably three or more further carrier plies, the carrier plies of the carrier layer being joined to one another preferably by intermediate adhesive layers.

In the estimation of the inventors, a preferred embodiment is in particular that in which the carrier layer comprises as additional ply a protective foil which shields the underlying carrier plies, especially the first carrier ply, from environmental effects and which is advantageous especially when the first carrier ply is formed of metal, since in this way it is also possible for unwanted corrosion and any resultant damage to the first carrier ply to be prevented, even over the long term. Preference is given to a method of the disclosure wherein the carrier layer comprises, as a further carrier ply, a protective foil on that side of the first carrier ply that is remote from the adhesive layer, the protective foil being preferably selected from the group consisting of polymeric foils, the protective foil with particular preference substantially completely covering the surface of the carrier layer.

In accordance with the disclosure, the continuous clearance is completely covered with the corresponding bonding elements and thereby fluid-tightly sealed. The skilled person understands accordingly that this type of overpressure protection, explained in more detail below, means that this fluid-tight seal can be broken open in the event of an acting pressure. For this, the bonding element in accordance with the disclosure comprises a weakening region in which the mean thickness of the carrier layer is reduced relative to the rest of the bonding element, so that in the weakening region the carrier layer has a reduced mechanical robustness and thereby represents a kind of predetermined breakage point in the carrier layer. The predetermined opening pressure, i.e. the pressure in response to which the overpressure protection is to act, may advantageously be adjusted via the extent of the weakening in the weakening region. Preference here is given to a method of the disclosure wherein the carrier layer in the weakening region has a mean thickness in the range from 5 to 150 μm, preferably in the range from 10 to 100 μm, particularly preferably in the range from 15 to μm, and/or wherein the mean thickness of the carrier layer in the weakening region is lower by 5% to 95%, preferably by 10% to 80%, particularly preferably by 20% to 60%, than the mean thickness of the carrier layer in the pressure opening region.

The skilled person therefore understands that the bonding element is configured to form a through hole in the event of the action of a predetermined opening pressure on the pressure opening region. In agreement with the understanding of the skilled person, this action of a predetermined opening pressure designates a pressure difference between the two sides of the bonding element of the kind which occurs, for example, if the bonding element is masking a clearance in an otherwise closed vessel and there is a pressure increase inside the vessel. For the skilled person it is clear that the predetermined opening pressure does not refer to the ambient pressure which is experienced in the same way on all sides and regions of the bonding element, and so there is no force effect which acts on the pressure opening region relative to the rest of the bonding element. In other words, therefore, the predetermined opening pressure denotes an opening pressure difference.

The expression “at least partly irreversibly destroyed” used in the context of the present disclosure means, in agreement with the understanding of the skilled person, that complete destruction of the weakening region is not necessary, as long as the destruction is sufficient to form a through hole in the bonding element. For example, a circular weakening region which completely surrounds a pressure opening region could be destroyed only over part of the circumference because of the predetermined opening pressure, so that the pressure opening region is removed from the bonding element only partly. Nor need the destruction be completely irreversible. As a result of the physicochemical properties of typical adhesives, especially their flow behavior, it would be conceivable at least theoretically for a pressure opening region pressed back into the bonding element to be able to be closed at least provisionally, via the interaction of the adhesive, in spite of the irreversibly destroyed carrier layer, in such a way that the raised pressure opening region is held in position by the adhesive layer.

Although it is theoretically conceivable to provide relatively large, extensive regions of reduced thickness, and such relatively complex weakening regions may be rational for specific applications, it is preferred in the estimation of the inventors, with a view to precise opening of the weakening region in conjunction with simple production, to embody these regions substantially in the form of a flute-like clearance, i.e. an elongated indentation, in the carrier layer. Preferred correspondingly is a method of the disclosure wherein the weakening region is embodied as a flute-like clearance in the carrier layer.

The skilled person understands that the resistance which the bonding element is able to offer to an acting pressure difference, after hole sealing, is definitively influenced by the mechanical robustness of the carrier layer and/or of the first carrier ply, whereas the contribution of the adhesive layer is lower, especially since this layer in many cases will be fluid to a certain extent. Accordingly it is useful, if the predetermined opening pressure is not to engage even at very low pressures, to embody the carrier layer without completely continuous perforations, in order to prevent premature passage of fluid at low pressures. Preference is given to a method of the disclosure wherein the weakening region comprises no clearance which completely penetrates the carrier layer, more particularly not the first carrier ply.

Because of the above-described definitive influencing of the predetermined opening pressure by the carrier layer and of the flow behavior of the adhesive, which is usually present in any case, it is advantageously not necessary to provide a corresponding reduction in mean thickness in the adhesive layer, in a manner complementary to the weakening region, and accordingly production can be simplified. Against this background, preference is given to a method of the disclosure wherein the mean thickness of the adhesive layer in the weakening region is lower by 20% or less, preferably by 10% or less, particularly preferably by 5% or less, especially preferably by 1% or less, more particularly preferably by 0.1% or less, than the mean thickness of the adhesive layer in the pressure opening region.

The skilled person understands that the dimensions of the pressure opening region are dependent on the profile of the weakening region. In its shape and its dimensions, therefore, the pressure opening region which is removed at least partly from the bonding element in the event of an overpressure is defined by the predetermined breakage point responsible for it, i.e. by the weakening region. Accordingly, in the estimation of the inventors, a multiplicity of basic shapes may be provided for the pressure opening region; with a view to simplicity of application and a secure hold of the bonding element on the substrate it is in many cases judicious to gear the shape of the pressure opening region to the shape of the clearance to be masked and to dispose the pressure opening region relatively centrally in the bonding element. Preferred, consequently, is a method of the disclosure wherein the pressure opening region has a basic shape selected from the group consisting of circles, part-circles, especially semicircles, ovals or polygons, preferably selected from the group consisting of circles, semicircles and ovals. Preferred, additionally or alternatively, is a method of the disclosure wherein the pressure opening region has a basic shape corresponding substantially to the cross section of the continuous clearance. Particularly preferred in all embodiments is a method of the disclosure wherein the center point of the bonding element lies in the pressure opening region.

The inventors have recognized that the method of the disclosure and the adhesive element for use therein make it possible, advantageously, to exert an influence, by comparatively small alterations in the production process for the bonding element, over factors including how wide the bonding element is opened when the overpressure protection is engaged, and hence to influence the fluid flow. A very wide-opening through hole is obtained here in particular when the pressure opening region is surrounded as extensively as possible by the weakening region. In this case it is of particular interest, in one embodiment, to surround the pressure opening region substantially completely with the weakening region, so that it is particularly easy to remove a pressure opening region, raised from the bonding element as a result of an acting overpressure, from the bonding element completely.

Preferred correspondingly is a method of the disclosure wherein the pressure opening region, based on the circumference of the pressure opening region, is surrounded by the weakening region to an extent of 50% or more, preferably 70% or more, particularly preferably 90% or more, especially preferably 95% or more, more particularly preferably substantially 100% of the circumference.

As an alternative embodiment to this, the inventors propose that it is possible deliberately not to provide a weakening region in a sub-portion of the circumference of the pressure opening region, so that there remains an unweakened connection between the raised pressure opening region and the rest of the bonding element, this unweakened connection enabling the advantageous prevention of the raised pressure opening region being able to be torn off too easily as a result of mechanical loading and remaining as a foreign body in the casing, for example. Preferred, therefore, is a method of the disclosure wherein the pressure opening region, based on the circumference of the pressure opening region, is not surrounded by the weakening region to an extent of 0.1% to 10%, preferably 0.2% to 5%, particularly preferably 0.5% to 2% of the circumference.

The weakening region in the bonding element, i.e. the local reduction of the mean thickness in the carrier layer, may be generated, in the estimation of the inventors, advantageously with a broad range of possible methods, with diecutting being suitable in particular for producing bonding elements in large quantities, whereas the use of laser structuring is suitable especially for establishing particularly precise weakening regions. Preferred accordingly is a method of the disclosure wherein the weakening region in the bonding element is produced by means of material-ablating or cutting processing methods, preferably by means of laser structuring or diecutting.

As part of the development of the present disclosure, the inventors experimented with different directions from which the material of the bonding elements can be processed. In a first attempt, the material was processed from the direction of the carrier layer, i.e. from the side remote from the adhesive layer. While this did give satisfactory weakening regions, a hindering factor nevertheless, especially in the case of mechanical processing methods, was in some cases that the action of force on the carrier layer also influences the underlying adhesive layer which may press, for example, against the surface beneath, possibly leading to unwanted adhesion and/or deformation of the adhesive layer. The inventors have recognized that, surprisingly, it is more easy to produce the weakening region when the carrier layer is processed from the side covered with the adhesive layer, i.e. when the processing takes place, so to speak, through the adhesive layer. This is possible, surprisingly, because the adhesive layer has a certain fluidity by virtue of the adhesive, and a local displacement of material, produced in the course of the processing of the carrier layer, can be compensated relatively simply over time. Preferred for some applications is a method of the disclosure wherein the weakening region in the bonding element is produced by processing that side of the carrier layer that is remote from the adhesive layer. Particularly preferred alternatively, however, is a method of the disclosure wherein the weakening region in the bonding element is produced by processing that side of the carrier layer that is covered with the adhesive layer, with the processing taking place preferably through the adhesive layer.

The skilled person understands that the predetermined opening pressure is definitively influenced by the design of the bonding element used and in particular by the dimensions and embodiments of the weakening region, and so the structural design of the bonding elements makes it possible to adjust the desired opening behavior with precision. In the estimation of the inventors, in the cases where the predetermined opening pressures are very low, an inherently reduced structural integrity of the overall bonding elements is obtained in many cases; here, manufacturing-related deviations in the weakening region, and the resultant absolute fluctuations in the predetermined opening pressure, may emerge as being relatively large relative uncertainties. Correspondingly, the inventors propose selecting not too low a predetermined opening pressure. At the same time, particularly high predetermined opening pressures at least indirectly pose relatively exacting requirements on the adhesives to be used and/or on their bond strength on the substrate, the intention being to prevent adhesive failure of the entire bonding element and hence premature venting before the opening of the pressure opening region. Correspondingly, the inventors propose not only purposive lower limits for the opening pressure but also ranges, and associated upper limits, which in the estimation of the inventors are judicious for numerous applications and can be effectively established using typical adhesives and carrier materials. Preferred is a method of the disclosure wherein the predetermined opening pressure is 10 kPa or more, preferably 15 kPa or more, particularly preferably 20 kPa or more, especially preferably 25 kPa or more, and/or wherein the predetermined opening pressure is in the range from 5 to 200 kPa, preferably in the range from 10 to 150 kPa, particularly preferably in the range from 15 to 100 kPa, especially preferably in the range from 2 to 50 kPa.

It may be seen as an advantage of the method of the disclosure that the necessary adhering of the bonding elements, especially in comparison with bursting systems known from the prior art, is particularly simple and, accordingly, is also easy to automate. Preferred correspondingly is also a method of the disclosure wherein the adhering of the bonding element takes place automatically, preferably using a robot arm.

For an optimum opening effect in the case of an acting overpressure, the inventors propose disposing the pressure opening region substantially concentrically over the continuous clearance. Preference is given to a method of the disclosure wherein the pressure opening region is disposed concentrically over the continuous clearance.

One particularly simple embodiment, which in particular exhibits a great flexibility in terms of the hole geometry to be sealed therewith, is obtained when the pressure opening region is smaller than the continuous clearance to be sealed, so that the continuous clearance in plan view lies completely above the pressure opening region. Preferred in these cases is a method of the disclosure wherein the pressure opening region has a smaller area than the cross section of the continuous clearance, the bonding element being preferably adhered such that the pressure opening region is disposed completely above the continuous clearance.

In the case of the above-described embodiment wherein the pressure opening region is surrounded completely by the edge of the continuous clearance, however, it has proven disadvantageous, in the inventors' own experiments, that it is more difficult to establish an anisotropic opening behavior. In other words, a corresponding embodiment is more likely to open—into the interior of a sealed casing, for example—as a consequence of an overpressure that acts from the carrier layer side, i.e. in the majority of applications, an overpressure which acts on the substrate from externally. While this may be desirable for certain embodiments, an opening behavior of this kind is perceived as disadvantageous for the majority of applications, especially in the area of the battery casing. In the course of the development, the inventors recognized that in order to establish the directional dependency of the opening behavior, the bonding element ought to be adhered such that the pressure opening region protrudes at least sectionally over the edge of the continuous clearance. The effect of this, advantageously, is that the overlap between the edge of the continuous clearance and the pressure opening region, together with the stiffness of the carrier layer, counteracts the unwanted opening of the pressure opening region in the direction of the sealed clearance. Particularly preferred, therefore, is a method of the disclosure wherein the bonding element is adhered such that the pressure opening region, based on the circumference of the continuous clearance, protrudes at least sectionally, preferably to an extent of 50% or more, particularly preferably 70% or more, especially preferably 90% or more, extremely preferably 95% or more, more particularly preferably to an extent of substantially 100% of the circumference, over the edge of the continuous clearance, and/or wherein the pressure opening region has a greater area than the cross section of the continuous clearance.

On the basis of this realization, the inventors recognized that via the degree of overlap it is also possible, advantageously, to adjust the loading pressure up to which the pressure opening region, in the event of a pressure acting from externally, i.e. from the direction of the carrier layer, is not removed from the bonding element, so that it is possible not only to achieve an advantageous anisotropy of the opening behavior but also to adjust it precisely in both directions as well. Particularly preferred, correspondingly, is also a method of the disclosure wherein the bonding element, by the at least sectional protrusion of the pressure opening region over the edge of the continuous clearance, is adhered such that the adhered bonding element withstands the action of a predetermined loading pressure on the carrier layer in the pressure opening region, so that the bonding element in the weakening region is not irreversibly destroyed and no through hole is formed in the bonding element. Especially preferred here is a method of the disclosure wherein the predetermined loading pressure is 100 kPa or more, preferably 200 kPa or more, particularly preferably 300 kPa or more, especially preferably 400 kPa or more.

In the above-described advantageous embodiment with an at least partial overlapping of the pressure opening region with the edge of the clearance, the inventors observed an effect which is able to limit the maximally free adjustment of the predetermined opening pressure with simultaneous adjustment of a predetermined loading pressure. Especially at high levels of overlap, which may be necessary for setting high loading pressures, it may be the case—at least with the preferred substantial covering of the carrier layer with an adhesive layer—that the adhesive interaction of the adhesive layer in the region of overlap makes a tangible contribution to the necessary opening pressure, since in this case it is also necessary, in order to raise the pressure opening region, to overcome the adhesion between the adhesive layer and the edge of the clearance. In this case, therefore, the predetermined opening pressure is no longer determined substantially by the weakening of the carrier layer; instead, the pressure needed for opening must also overcome the adhesive interaction between the adhesive layer and the substrate. In order to be able to realize even small predetermined opening pressures in spite of large predetermined loading pressures, i.e., for example, in spite of high resistance to external loading factors, a solution proposed by the inventors is to provide an additional masking element which can be applied to the adhesive layer and which in its dimensions expediently corresponds as largely as possible to the dimensions of the pressure opening region. In this case, the masking element reduces or prevents an adhesive interaction between the adhesive layer in the region of the pressure opening region, and the substrate, so that the bonding element is secured on the substrate, for example, exclusively via the adhesive interaction of the adhesive layer outside the pressure opening region. Under the action of a pressure occurring from externally, i.e. from the side remote from the adhesive layer, the bonding element, as a result of the overlap, presents a resistance to unwanted opening that can be increased still further, advantageously, by the additional structural integrity of the masking element, since this element as well would first have to be deformed in order for breaking-open to take place. Looked at from the other direction, however, the masking element prevents an adhesive interaction between the relevant part of the adhesive layer and the edge of the substrate in the region which is to be raised up on overpressure opening, and so permits, in turn, the establishment even of low predetermined opening pressures. Particularly preferred, accordingly, is a method of the disclosure wherein the bonding element additionally comprises a masking element which is mounted in the pressure opening region on that side of the adhesive layer that is remote from the carrier layer, with the masking element preferably substantially not protruding over the pressure opening region and/or with the dimensions of the masking element preferably corresponding substantially to the dimensions of the pressure opening region, or with the continuous clearance being at least partly, preferably completely, covered with a masking element before the bonding element is adhered, with the dimensions of the masking element preferably corresponding substantially to the dimensions of the pressure opening region, with the bonding element being adhered such that the pressure opening region at least partly, preferably completely, covers the masking element. The skilled person understands that a method of the disclosure that is expedient is one wherein the masking element does not comprise an adhesive. Preferred, instead, is a method of the disclosure wherein the masking element comprises a foil selected from the group consisting of polymeric foils and metal foils.

The inventors have succeeded accordingly in specifying expedient dimensions for the adhesive layer, the carrier layer and the masking element. Preferred, indeed, is a method of the disclosure wherein the adhesive layer has a mean thickness in the range from 5 to 1500 μm, preferably in the range from 10 to 500 μm, particularly preferably in the range from 35 to 100 μm, and/or wherein the carrier layer has a mean thickness in the range from 30 to 2000 μm, preferably in the range from 40 to 1000 μm, particularly preferably in the range from 50 to 500 μm, and/or wherein the masking element has a mean thickness in the range from 5 to 340 μm, preferably in the range from 10 to 200 μm, particularly preferably in the range from 12 to 100 μm.

The skilled person understands that the disclosure also relates to a bonding element which can be used in the method of the disclosure and with which the above-described advantages may be obtained. The disclosure therefore likewise relates to a bonding element for permanently sealing holes with overpressure protection, preferably in a method of the disclosure, comprising:
i) an adhesive layer comprising an adhesive, and
ii) a carrier layer disposed on the adhesive layer and comprising a first carrier ply,
wherein the bonding element comprises a pressure opening region which is surrounded at least sectionally by a weakening region formed in the carrier layer, the mean thickness of the carrier layer in the weakening region being lower than the mean thickness of the carrier layer in the pressure opening region, wherein the bonding element is configured such that the action of a predetermined opening pressure on the pressure opening region at least partly irreversibly destroys the bonding element in the weakening region and forms a through hole in the bonding element.

In the estimation of the inventors it is not only the method of the disclosure and the bonding element of the disclosure that is employed therein that are advantageous; instead, the advantages also transfer directly to the substrates produced accordingly, which possess an advantageous overpressure protection, with in particular the low inherent weight and the low inherent volume of the bonding elements of the disclosure, and also the reliable opening at predetermined opening pressures, resulting in overpressure-protected substrates which are particularly suitable for numerous applications, particularly in the area of electric vehicles, as for example in the form of battery casings. The disclosure also relates, correspondingly, to an overpressure-protected substrate, preferably producible with the method of the disclosure, comprising a fluid-tightly sealed interior having at least one fluid-tightly sealed opening, the sealed opening being fluid-tightly sealed with a bonding element of the disclosure, wherein the pressure opening region of the bonding element at least partly covers the sealed opening, wherein the overpressure-protected substrate is configured such that as a consequence of a predetermined overpressure in the interior, the bonding element is at least partly irreversibly destroyed in the weakening region, so that the pressure in the interior can be relieved by the through hole formed in the bonding element.

Lastly, the disclosure is also directed to the use of a bonding element of the disclosure for permanently sealing a hole in a substrate and for producing an overpressure protection, the hole being sealed with the bonding element such that the pressure opening region at least partly covers the hole in the substrate.

### BRIEF DESCRIPTION OF THE DRAWINGS

Below, preferred embodiments of the disclosure are described and elucidated in more detail with reference to the appended figures, in which:

FIG. 1 shows a first schematic exploded representation of the structure of a bonding element before application to the substrate in an embodiment;

FIG. 2 shows a second schematic exploded representation of the structure of a bonding element before application to the substrate in an embodiment;

FIG. 3 shows a schematic cross-sectional representation through a bonding element in an embodiment;

FIG. 4 shows a schematic representation of an overpressure-protected substrate with its overpressure protection closed; and

FIG. 5 shows a schematic representation of an overpressure-protected substrate with its overpressure protection opened.

### DETAILED DESCRIPTION OF THE DISCLOSURE

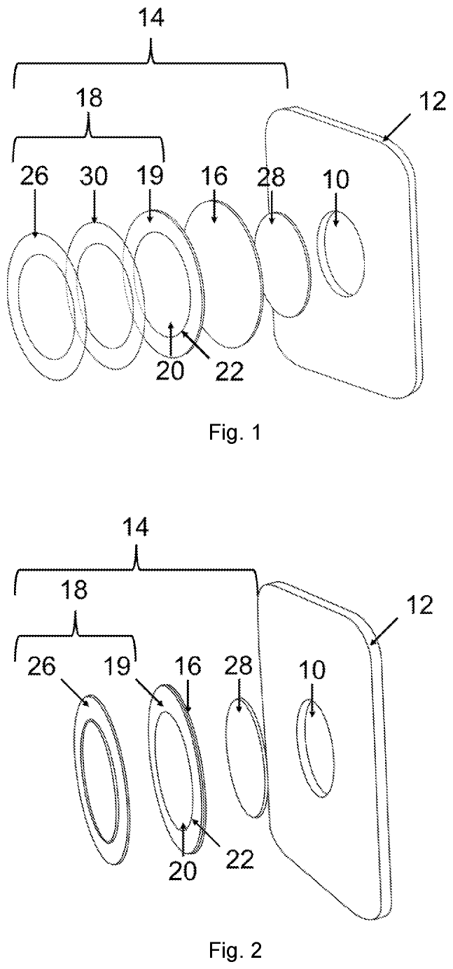

FIG. 1 shows a first schematic exploded representation of the structure of a bonding element 14 of the disclosure before application to the substrate 12, as takes place in a method of the disclosure.

The bonding element 14 of the disclosure comprises an adhesive layer 16 via which the bonding element can be mounted on the substrate 12 such that the continuous clearance 10 in the substrate 12 is fluid-tightly, more particularly gastightly, sealed. In the example shown in FIG. 1, the substrate 12 is a metallic battery casing, with only one wall of the battery casing delimiting its interior being shown.

In the example shown, the adhesive layer 16 comprises a pressure-sensitive adhesive (PSA) based on poly(meth)acrylates, which may also be syntactically foamed by the use of expanded microballoons, for example.

The adhesive layer 16 is arranged on the first carrier ply 19 of a multi-ply carrier layer 18, to which it is connected via the adhesion of the adhesive. In the example shown in FIG. 1, it is evident from the exploded representation that the first carrier ply 19 is covered substantially completely by the adhesive layer 16 on one side, as becomes clearer from the representation in FIG. 2, in which the exploded representation of FIG. 1 is partially merged, so that the connection of the first carrier ply 19 and the adhesive layer 16 becomes clear.

In FIGS. 1 and 2, the first carrier ply 19 is a metal foil having a mean thickness of about 80 μm. Beyond the first carrier ply 19, the carrier layer 18 comprises a protective foil 26 of polyethylene terephthalate as a further ply, which is connected to the first carrier ply 19 via a likewise extensively applied intermediate adhesive layer 30.

Clearly evident in each of FIGS. 1 and 2 is that the bonding element 14 in the carrier layer 18 comprises a pressure opening region 20 which is formed by a weakening region 22. The pressure opening region 20 here lies centrally in the bonding element 14 and in the example shown is substantially circular, so that it therefore, in terms of basic shape, corresponds substantially to the continuous clearance 10 in the substrate 12 that is to be sealed in the method of the disclosure.

As a result of this structure, the bonding element 14 of the disclosure is configured such that the action of a predetermined opening pressure on the pressure opening region 20, as a consequence, for example, of an overpressure prevailing in the interior of the substrate 12, is able in the weakening region 22 to bring about an at least partly irreversible destruction, by which a through hole 24 is formed in the bonding element 14.

In the example shown, the weakening region 22 is formed as a flute-like clearance in the carrier layer 18, which extends through the protective foil 26 into the first carrier ply 19 and substantially completely surrounds the pressure opening region 20, with the mean thickness of the carrier layer 18 in the region of the weakening region 22 being reduced by about 20 to 60%, depending on desired opening pressure, relative to the original thickness of the carrier layer 18 and hence also relative to the mean thickness thereof in the pressure opening region 20.

In FIG. 1 it is evident that in the example shown, the adhesive layer 16 has a substantially constant mean thickness, this being conditioned by mechanical formation of the weakening region 22, which in this case has taken place from the direction of the carrier layer 18, by diecutting; the adhesive layer 16 is not affected by this diecutting.

In the examples of FIGS. 1 and 2, in the method of the disclosure, the bonding element 14 of the disclosure is adhered, for example, automatically using a robot arm, with the pressure opening region 20 and the continuous clearance 10 being disposed concentrically in the example shown. In order to achieve advantageous anisotropy of the opening behavior, the adhering here takes place such that the pressure opening region 20 over the entire circumference of the continuous clearance 10 protrudes over the edge of the continuous clearance 10, so that the overlap is able to present a resistance to a loading pressure acting from externally.

In order to permit precise adjustment of the desired opening pressure in spite of the overlap of the bonding element 14 of the disclosure with the edge of the continuous clearance 10, the bonding element 14 of the disclosure comprises a masking element 28 which is formed of polymeric foil and whose dimensions correspond substantially to those of the pressure opening region 20, and which substantially completely covers the adhesive layer 16 in the pressure opening region 20.

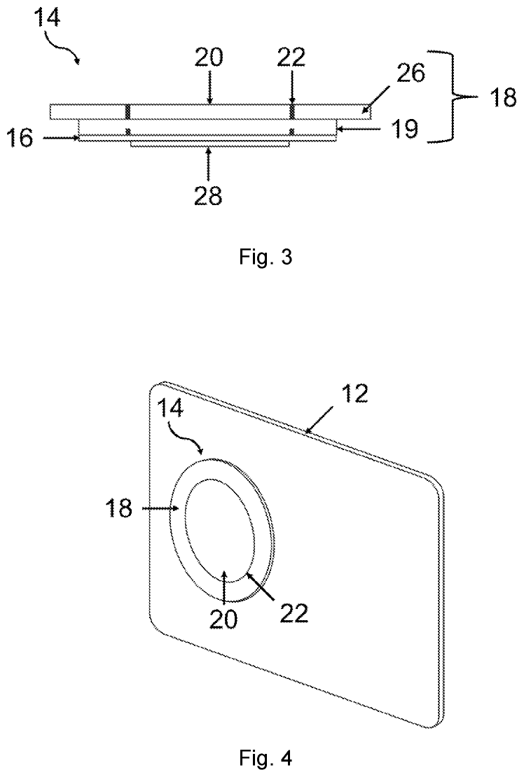

FIG. 3 visualizes the construction of a bonding element 14 of the disclosure in a cross-sectional representation, with the schematically represented bonding element 14 having a construction which in many aspects corresponds to that of the bonding element 14 of FIGS. 1 and 2. In FIG. 3, however, it is indicated that the processing of the carrier layer 18 for the purpose of producing the weakening region 22 may also take place at least partly through the adhesive layer 16; advantageously, as a result of the flow behavior of the adhesive layer 16, no traces of processing, in the form of a reduced thickness, for example, remain in this layer 16 after just a short time.

FIG. 4, then, shows an overpressure-protected substrate 12 of the disclosure with a continuous clearance 10 which is fluid-tightly sealed by the bonding element 14, as may be obtained, for example, starting from FIGS. 1 and 2. Because of the above-described construction of the bonding element 14 and the disposition thereof over the continuous clearance 10, the overpressure-protected substrate 12 can be designed such that it withstands a loading pressure, acting from the direction of the carrier layer 18, of 400 kPa or more without any destruction of the bonding element 14 in the weakening region 22. In fact, a corresponding construction has even been able, in the experiments by the inventors, to withstand the blasting of the overpressure-protected substrate 12 with a high-pressure water-jet cleaner (IPX9K, ISO 20653:2013) without any failure of the seal.

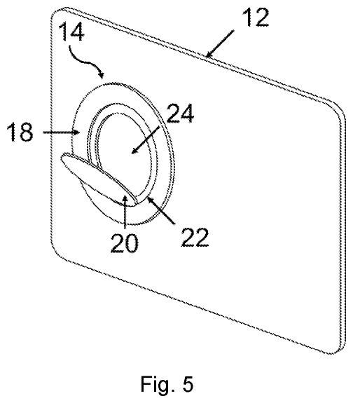

At the same time it is possible to establish a predetermined opening pressure in a targeted way, in the range from 5 to 200 kPa, for example, which when it acts in the desired opening direction, i.e., for example, from the interior of the battery casing to the exterior, raises the pressure opening region 20 from the bonding element 14, as a result of an at least partial destruction of the weakening region 22, and thereby forms a through hole 24 through which the overpressure can be released. The end state resulting from the engagement of the overpressure protection is visualized schematically in FIG. 5; here, in advantageous embodiments, the complete detachment of the pressure opening region 20 from the bonding element 14 is additionally prevented by the fact that the weakening region 22 is not made over the entire circumference, and so an unweakened connection remains between the pressure opening region 20 and the rest of the bonding element 14.

### LIST OF REFERENCE SYMBOLS

10 Continuous clearance
12 Substrate
14 Bonding element
16 Adhesive layer
18 Carrier layer
19 First carrier ply
20 Pressure opening region
22 Weakening region
24 Through hole
26 Protective foil
28 Masking element
30 Intermediate adhesive layer

1. A method for sealing a continuous clearance in a substrate, the method comprising:
a) producing or providing a bonding element comprising:
i) an adhesive layer comprising an adhesive,
ii) a carrier layer disposed on the adhesive layer and comprising a first carrier ply; and
b) adhering the bonding element by means of the adhesive layer to the substrate such that the bonding element completely covers the continuous clearance and the continuous clearance is fluid-tightly sealed by the bonding element,
wherein
the bonding element comprises a pressure opening region that is surrounded at least sectionally by a weakening region formed in the carrier layer, the mean thickness of the carrier layer in the weakening region being lower than the mean thickness of the carrier layer in the pressure opening region,
the bonding element is configured such that the action of a predetermined opening pressure on the pressure opening region at least partly irreversibly destroys the bonding element in the weakening region and forms a through hole in the bonding element, and
the bonding element is adhered such that the pressure opening region at least partly covers the continuous clearance in the substrate.

2. The method of claim 1, wherein the weakening region is formed as a flute-like clearance in the carrier layer.

3. The method of claim 1, wherein the predetermined opening pressure is 10 kPa or more.

4. The method of claim 1, wherein the carrier layer comprises a protective foil as a further carrier ply on that side of the first carrier ply that is remote from the adhesive layer.

5. The method of claim 1, wherein the bonding element further comprises a masking element that is mounted in the pressure opening region on the side of the adhesive layer that is remote from the carrier layer.

6. The method of claim 1, wherein the bonding element is adhered, by the at least sectional protrusion of the pressure opening region over the edge of the continuous clearance, such that the adhered bonding element withstands the action of a predetermined loading pressure on the carrier layer in the pressure opening region, so that the bonding element is not irreversibly destroyed in the weakening region and no through hole is formed in the bonding element.

7. The method of claim 6, wherein the predetermined loading pressure is 100 kPa or more.

8. A bonding element for permanently sealing continuous clearances with overpressure protection, the bonding element comprising:
i) an adhesive layer comprising an adhesive; and
ii) a carrier layer disposed on the adhesive layer and comprising a first carrier ply,
wherein
the bonding element comprises a pressure opening region that is surrounded at least sectionally by a weakening region formed in the carrier layer, the mean thickness of the carrier layer in the weakening region being lower than the mean thickness of the carrier layer in the pressure opening region, and
the bonding element is configured such that the action of a predetermined opening pressure on the pressure opening region at least partly irreversibly destroys the bonding element in the weakening region and forms a through hole in the bonding element.

9. An overpressure-protected substrate, comprising a fluid-tightly sealed interior having at least one fluid-tightly sealed opening, the sealed opening being fluid-tightly sealed with the bonding element of claim 8, wherein the pressure opening region of the bonding element at least partly covers the sealed opening,
wherein the overpressure-protected substrate is configured such that as a consequence of a predetermined overpressure in the interior, the bonding element is at least partly irreversibly destroyed in the weakening region, so that the pressure in the interior can be relieved by the through hole formed in the bonding element.

10. A method comprising:
permanently sealing a continuous clearance in a substrate with the bonding element of claim 8,
wherein the continuous clearance is sealed with the bonding element such that the pressure opening region at least partly covers the continuous clearance in the substrate.
